(19) United States
(12) Patent Application Publication
(10) Pub. No.: US 2024/0342828 A1
(43) Pub. Date: Oct. 17, 2024

(54) METHOD AND DEVICE FOR CREATING A PATTERN FIGURE CONSISTING OF PATTERN POINTS IN A WORKPIECE, MACHINING DEVICE, AND COMPUTER PROGRAM PRODUCT

(71) Applicant: JENOPTIK Automatisierungstechnik GmbH, Jena (DE)

(72) Inventors: André KERN, Jena (DE); Jan LANGEBACH, Jena (DE); Christian DOERING, Jena (DE); Benjamin GRABIGER, Jena (DE)

(73) Assignee: JENOPTIK Automatisierungstechnik GmbH, Jena (DE)

(21) Appl. No.: 18/638,305

(22) Filed: Apr. 17, 2024

(30) Foreign Application Priority Data
Apr. 17, 2023 (DE) 10 2023 109 575.7

(51) Int. Cl. B23K 26/082; B23K 26/03; B23K 26/359; B23K 26/362

(52) U.S. Cl. CPC B23K 26/082; B23K 26/032; B23K 26/359; B23K 26/362

(57) ABSTRACT

A method for creating a pattern figure formed of pattern points, in a workpiece, using a laser device of a machining device comprises reading in first position data, which define positions of first pattern points on the workpiece, wherein the first pattern points are associated with a first portion of a polyline of the pattern figure associated with the first pattern, introduction of the first pattern points into the workpiece taking place while the machining device is located in a first position, a detection of a course of an end of the first portion of the polyline, a continuation of the course of the end of the first portion of the polyline, and an introduction of second pattern points of a second portion of the polyline into the workpiece using the continued course, while the machining device is in a second position.

This nonprovisional application claims priority under 35 U.S.C. § 119 (a) to German Patent Application No. 10 2023 109 575.7, which was filed in Germany on Apr. 17, 2023, and which is herein incorporated by reference.

### BACKGROUND OF THE INVENTION

### Field of the Invention

The present invention relates to a method and device for creating a pattern figure formed of pattern points in a workpiece, a machining device, and a computer program product.

### Description of the Background Art

Pattern figures are generated for example in painted vehicle components via laser ablation. For example, what are known as galvanometer scanners are used for this purpose.

DE 10 2021 109 043 A1, which corresponds to US 2024/0033847, which is herein incorporated by reference, describes a method for controlling a laser machining process of a surface of a workpiece.

DE 10 2011 106 097 A1 describes a method for machining a workpiece, according to which the laser beam generates a plurality of laser markings, spaced apart from one another, as points of at least one predetermined space curve, via beam guidance.

EP 4 000 792 A1, which corresponds to US 2022/0152739 discloses a laser ablation method for engraving a workpiece with a texture.

In WO 2008/113 535 A1, which corresponds to US 2010/0147815, a laser beam is guided over the workpiece surface via beam guidance, within a working window.

WO 2010/126 864 A1, which corresponds to US 2010/0272961, describes a graphics system having a staggered laser etching line, the associated method, and corresponding articles of manufacture.

### SUMMARY OF THE INVENTION

It is therefore an objection of the present invention to provide an improved method and an improved device for creating a pattern figure formed of pattern points, in a workpiece, and an improved machining device, and a corresponding computer program, according to the main claims.

The described approach allows seamless introduction of a large-area pattern figure extending over different scanning fields of a laser device.

A method for creating a pattern figure formed of pattern points, in a workpiece, using a laser device of a machining device, the pattern figure being composed at least of a first pattern and a second pattern related to the first pattern:
Reading in first position data which define positions of first pattern points on the workpiece, the first pattern points being associated with a first portion of a polyline of the pattern figure associated with the first pattern;
Setting a first position of the machining device in order to align a scanning field of the laser device onto a first surface of the workpiece provided for introducing the first pattern;
Actuating the laser device for introducing the first pattern points into the first surface of the workpiece using the first position data, while the machining device is in the first position;
Setting a second position in order to align the scanning field of the laser device to a second surface of the workpiece provided for introducing the second pattern;
Detecting a course of an end of the first portion of the polyline adjoining the second surface;
Continuing the course of the end of the first portion of the polyline into the second surface in order to determine a position of a reference point of a second portion of the polyline associated with the second pattern and arranged in the second surface;
Reading in second position data which define positions of second pattern points on the workpiece, the second pattern points being associated with the second portion of the polyline, an end point of the first pattern points and a starting point of the second pattern points defining a transition of the polyline from the first pattern to the second pattern, and an end point of the second pattern points defining an end of the polyline in the second pattern;
Determining adapted second position data that define positions of the second pattern points on the workpiece adapted to the position of the reference point, a position of the starting point of the second pattern points being replaced by the position of the reference point; and
Actuating the laser device for introducing the second pattern points into the second surface of the workpiece using the adapted second position data, while the machining device is in the second position.

The steps of the method can advantageously be carried out at least partially repeatedly, in order to introduce the pattern figure into the workpiece over a large area using a plurality of positions of the machining device.

In order to produce a clean transition of the pattern figure between two successive positions, the step of detecting can comprise a step of aligning an image acquisition device of the machining device with the transition of the polyline from the first pattern to the second pattern, a step of acquiring an image of the transition using the image acquisition device, a step of detecting images of first pattern points in the image, and a step of determining the course of the end of the first portion of the polyline using the images of first pattern points. The alignment of the image acquisition device can be achieved, for example, by aligning a viewing angle of the image acquisition device, for example using a scanner.

The step of detecting can comprise a step of underlighting the transition of the polyline from the first pattern to the second pattern. The pattern points already introduced can thereby be clearly recognized.

In the continuation step, the course of the end of the first portion of the polyline can be continued into the second surface by linear regression. Recourse can thus be made to a known and simple method.

In order to cleanly produce an end point of a polyline of the pattern figure, in the step of determining adapted second position data, an adapted position of the end point of the second pattern points can be deleted if a length of the second portion of the polyline defined by the adapted positions of second pattern points on the workpiece is longer than a predetermined length of the second portion of the polyline.

Additionally or alternatively, for this purpose, in the step of determining adapted second position data, a distance between adjacent adapted positions of the second pattern points relative to a distance between adjacent positions of the second pattern points can be changed if a length of the second portion of the polyline defined by the adapted positions of second pattern points on the workpiece differs from a predetermined length of the second portion of the polyline.

In order to introduce at least one further polyline into the workpiece, in addition to the mentioned polyline, in the step of reading in first position data, the first position data can further define positions of further first pattern points on the workpiece, the further first pattern points being associated with a first portion of a further polyline of the pattern figure associated with the first pattern. Furthermore, in the step of actuating the laser device for introducing the first pattern points, the laser device can furthermore be actuated for introducing the further first pattern points into the first surface of the workpiece using the first position data, while the machining device is in the first position. In a repeated step of detecting, a course of an end of the first portion of the further polyline adjacent to the second surface can be detected. In a repeated step of continuing, the course of the end of the first portion of the further polyline can be continued into the second surface, in order to determine a position of a further reference point, arranged in the second surface, of a second portion of the further polyline associated with the second pattern. In the step of reading in second position data, the second position data can furthermore define positions of further second pattern points on the workpiece, the further second pattern points being associated with the second portion of the further polyline, an end point of the further first pattern points and a starting point of the further second pattern points defining a transition of the further polyline from the first pattern to the second pattern, and an end point of the further second pattern points defining an end of the further polyline in the second pattern. In the step of determining adapted second position data, the adapted second position data can be determined, which further define positions of the further second pattern points on the workpiece that are adapted to the position of the further reference point, it being possible for a position of the starting point of the further second pattern points to be replaced by the position of the further reference point. In the step of actuating the laser device for introducing the second pattern points, the laser device can furthermore be actuated for introducing the further second pattern points into the second surface of the workpiece, using the adapted second position data, while the machining device is in the second position.

In order to introduce at least one additional polyline into the workpiece, in addition to the mentioned polyline, which merges with the polyline, in the step of reading in first position data, the first position data can further define positions of additional first pattern points on the workpiece, the additional first pattern points being associated with a first portion of an additional polyline of the pattern figure associated with the first pattern. Furthermore, in the step of actuating the laser device for introducing the first pattern points, the laser device can furthermore be actuated for introducing the additional first pattern points into the first surface of the workpiece using the first position data, while the machining device is in the first position. In the step of detecting, a course of an end of the first portion of the additional polyline adjacent to the second surface can furthermore be detected. In the step of continuing, the course of the end of the first portion of the additional polyline can furthermore be continued into the second surface, in order to determine a position of an additional reference point, arranged in the second surface, of a second portion of the additional polyline associated with the second pattern. In the step of reading in second position data, the second position data can further define positions of additional second pattern points on the workpiece, the additional second pattern points being associated with a second portion of the additional polyline associated with the second pattern, an end point of the additional first pattern points and a starting point of the additional second pattern points defining a transition of the additional polyline from the first pattern to the second pattern, and an end point of the additional second pattern points defining an end of the additional polyline in the second pattern, the position of the end point of the second pattern points coinciding with the position of the end point of the additional second pattern points, in order to merge the ends of the polyline and the additional polyline. In the step of determining adapted second position data, the adapted second position data can be determined, which further define positions of the additional second pattern points on the workpiece that are adapted to the position of the additional reference point, it being possible for a position of the starting point of the additional second pattern points to be replaced by the position of the additional reference point. In the step of actuating the laser device for introducing the second pattern points, the laser device can furthermore be actuated for introducing the additional second pattern points into the second surface of the workpiece, using the adapted second position data, while the machining device is in the second position.

In order to be able to cleanly merge the polyline and the additional polyline, in the step of determining adapted second position data, a distance between adjacent adapted positions of the additional second pattern points with respect to a distance between adjacent positions of the additional second pattern points can be changed, if a length of the second portion of the additional polyline defined by the adapted positions of additional second pattern points on the workpiece is longer than a predetermined length of the second portion of the additional polyline.

As a preparation, the method can comprise a step of morphing the pattern figure to a height profile of the workpiece, a step of defining the first position and the second position of the machining device, and a step of dividing the pattern figure into the first pattern and the second pattern. Morphing can be understood to mean targeted distortion of the pattern figure. For example, a pattern figure originally present in two-dimensional form can thereby be transferred into a three-dimensional pattern figure adapted to the height profile of the workpiece.

Optionally, the method can in this case comprise a step of acquiring the height profile of the workpiece.

This method can be implemented, for example, in software or hardware or in a mixed form made up of software and hardware, for example in a control device.

A corresponding device for creating a pattern figure formed of pattern points, in a workpiece, using a laser device of a machining device, is designed to carry out and/or actuate the steps of an example of the mentioned method, in corresponding units.

Accordingly, a machining device can comprise a mentioned laser device and a mentioned device.

The device is designed to carry out, actuate or implement the steps of a variant of a method presented here, in corresponding devices. The object on which the invention is based can also be achieved quickly and efficiently via this example variant of the invention in the form of a device.

For this purpose, the device can have at least one computing unit for processing signals or data, at least one storage unit for storing signals or data, at least one interface to a sensor or an actuator for reading sensor signals from the sensor or for outputting data or control signals to the actuator, and/or at least one communication interface for reading or outputting data that are embedded in a communication protocol. The computing unit can, for example, be a signal processor, a microcontroller, or the like, it being possible for the memory unit to be a flash memory or a magnetic memory unit. The communication interface can be designed to read or output data wirelessly and/or in a line-bound manner, a communication interface that can read or output line-bound data being able, for example, to read these data electrically or optically from a corresponding data transmission line or output them into a corresponding data transmission line.

In the present case, a device can be understood to mean an electrical device that processes sensor signals and as a function thereof outputs control and/or data signals. The device may have an interface, which may be designed as hardware and/or software. In a hardware example, the interfaces can, for example, be part of what is known as an ASIC system, which includes a wide variety of functions of the device. However, it is also possible for the interfaces to be separate integrated circuits or at least partially formed of discrete components. In a software design, the interfaces may be software modules which, for example, are present on a microcontroller in addition to other software modules.

Also advantageous is a computer program product or computer program with program code which can be stored on a machine-readable carrier or storage medium, such as a semiconductor memory, a hard disk memory, or an optical memory, and is used to carry out, implement, and/or control the steps of the method according to one of the examples described above, in particular if the program product or program is executed on a computer or a device.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a machining device for machining a workpiece;

FIG. 2 is a schematic view of a pattern figure on a workpiece according to an example;

FIG. 3 shows a region of the pattern figure shown in FIG. 2;

FIG. 4 shows a further region of the pattern figure shown in FIG. 2;

FIG. 5 shows a region of a pattern figure;

FIG. 6 is an illustration of support points of a portion of a polyline;

FIG. 7 is an illustration of the portion of the polyline shown in FIG. 6, having pattern points supplemented between the support points;

FIG. 8 is an illustration of the portion of the polyline shown in FIG. 6, having pattern points supplemented between the support points;

FIG. 9 is a flow diagram of a method for creating a pattern figure formed of pattern points, in a workpiece;

FIG. 10 is a flow diagram of a method for creating a pattern figure formed of pattern points, in a workpiece; and

FIG. 11 is a schematic view of a pattern figure 108 on a workpiece 102.

### DETAILED DESCRIPTION

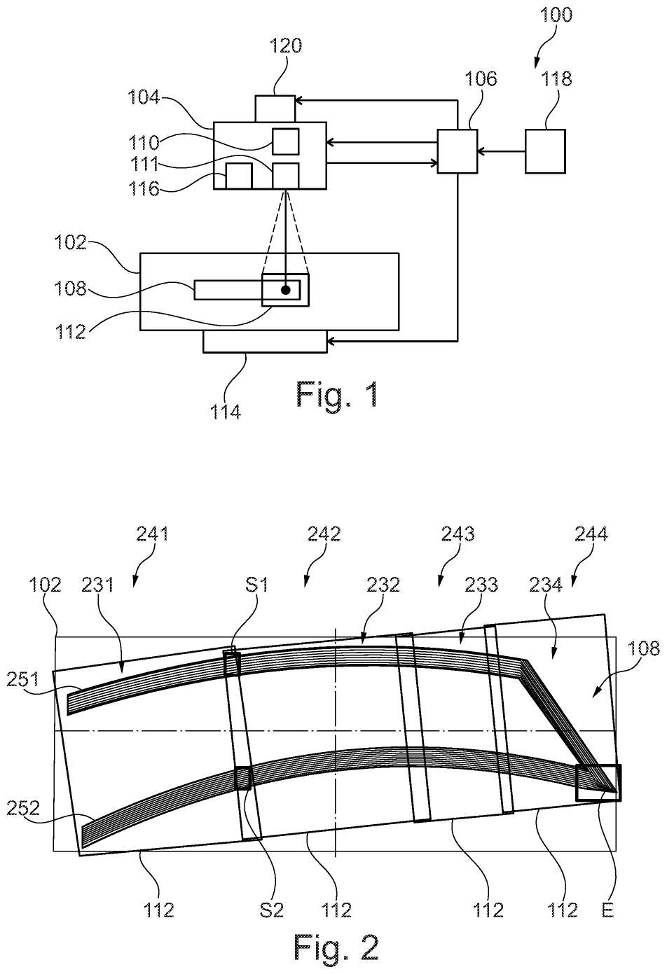

FIG. 1 shows an example of a machining device 100 for machining a workpiece 102. The machining device 100 comprises a laser device 104 and a device 106 for creating a pattern figure formed of pattern points 108, in the workpiece 102, using the laser device 104. According to an example, the device 106 is formed as a control device of the machining device 100, and is designed for controlling an operation of the machining device 100.

The laser device 104 comprises a laser 110 which is designed to emit a laser beam in the direction of the workpiece 102, when the workpiece 102 is received by the machining device 100. The laser 110 is associated with a scanning field 112. The laser beam of the laser 110 can be moved such that the laser beam can sweep over the entire scanning field 112. For example, the laser device 104 or laser 110 comprises a steering device 111, for example in the form of a scanner, for steering the laser beam in a desired direction. The laser 110 is used, according to this example, in order to introduce pattern points into the workpiece 102 at different positions arranged within the scanning field 112.

in the state shown in FIG. 1, the machining device 100 is in a first position, in which the laser device can introduce, into the workpiece 102, only pattern points of the pattern figure located within the scanning field 112. Since the pattern figure extends beyond the scanning field 112, a transfer of the machining device 100 into a second position is required, in which second position the laser device can for example introduce the remaining pattern points of the pattern figure into the workpiece 102. In order to transfer the machining device 100 from the first position into the second position, a relative position between the laser device 104 and the workpiece 102 is changed. Optionally, the machining device 100 comprises a holding device 114 which is designed to hold the workpiece 102 and optionally move it relative to the laser device 104. For example, the holding device 114 is designed to move the workpiece 102 during the transfer of the machining device 100 from the first position into the second position. Optionally, the machining device 100 comprises a movement device 120 which is designed form moving the laser 110 and/or the laser device 104 relative to the workpiece 102. For example, the movement device 120 is designed to move the laser 110 during the transfer of the machining device 100 from the first position into the second position.

According to an example, the machining device 100 comprises an image acquisition device 116 which is designed for acquiring an image of the workpiece 102. For example, the image acquisition device 116 is integrated into the laser device 104. According to an example, the steering device 111 or alternatively a further scanner is additionally used in order to adjust a viewing direction of the image acquisition device 116.

According to an example, the device 106 is designed to provide a first control signal for controlling an operation of the laser device 104, and optionally a second control signal for controlling an operation of the holding device 114, and optionally a third control signal for controlling an operation of the movement device 120. For example, the first control signal is suitable for aligning the laser 110 in such a way that the laser beam is directed to a position within the scanning field at which a pattern point of the pattern figure 108 is to be introduced in the workpiece 102. For example, the second control signal is suitable for actuating the holding device 104 in such a way that the workpiece is moved into a situation associated with a position to be assumed. For example, the third control signal is suitable for actuating the movement device 120 such that the laser 110 is moved into a situation associated with the position to be assumed. According to an example, the device 106 is designed to read in an image signal which comprises an image of the workpiece 102 acquired by the image acquisition device 116. According to an example, the device 106 is designed to read data, relating to the pattern figure 108, into a storage device 118 via an interface. For example, the data comprise position data which define positions of pattern points of the pattern figure on the workpiece 102. In this case, the position data can be predetermined. According to an example, the device 106 is designed to adjust at least one portion of read-in position data, in order to ensure a continuous transition from first pattern points to second pattern points during a transition between two positions, the first pattern points having been introduced into the workpiece 102 while the machining device 100 was in the first position, and the second pattern points having been introduced into the workpiece 102 while the machining device 100 was in the second position.

The machining device 100 is suitable for machining a surface of the workpiece 102 via a laser machining process. For example, the laser device 102 comprises a machining head comprising the image acquisition device 116 in the form of an optical acquisition device, the laser 110, and the steering device 111 for steering the laser beam of the laser 110 onto the workpiece 102. The steering device 111 comprises, for example, a movable mirror, via which the laser beam can be successively steered in the direction of different positions within the scanning field 112.

A dimension of the scanning field 112 results, according to an example, from a maximum possible deflection of the laser beam in the x, y and z directions. According to an example, the laser device 104 or the laser 110 comprises a galvanometer scanner for deflecting the laser beam in the direction of the workpiece 102.

Using the machining device 100, a method can be carried out or implemented as described with reference to the following figures. For example, the device 106 is used to actuate or execute corresponding method steps of such a method.

According to an example, the described approach relates to a method for producing at least one pattern figure comprising a plurality of pattern points, for example the pattern figure 108, on three-dimensional workpieces, such as the workpiece 102, via the laser 110, in conjunction with a scanner, such as the steering device 111. The pattern points are created in the workpiece 102 by a material removal via laser ablation.

As an example, the removal of layers on the workpiece is 102 in the form of a painted vehicle component is cited. The resulting pattern figure can be back-lit and thus offer possibilities for information outputs to road users, but also for personalized designs.

The described approach relates in particular to large-area pattern figures which exceed the technically possible geometric dimensions of the scanning field 112. In this case it is a question, on the one hand, of the seamless “joining together” of individual scanning fields, and in this case in particular the seamless transition from “start” and “end” in the case of closed contours of the pattern figure 108.

For this purpose, the machining device 100 or a comparable device according to an example is actuated in such a way that, in the laser process, the uniform arrangement of pattern elements of the pattern figure 108 during “joining together” of the scanning fields is implemented, or uniform machining takes place in the case of geometric or design-related boundaries on the workpiece 102.

Furthermore, the uniform application of pattern elements in closed contours of the pattern figure 108 is made possible. In this case, according to an example the transition from the beginning of the laser process to the “start” of the pattern figure 108 and the completion of the laser process at the “end” of the pattern figure 108 is designed such that it is not visible for the viewing eye of a person.

Some terms which are used in the following figures are explained below: Polyline: A polyline is understood to mean a structured succession of lines, each line being defined by two support points (SP) in three-dimensional space. The end point of one line is the starting point of the next line. Support points are pure auxiliary data and are not lasered.

Pattern points: Pattern points are understood to mean points along the polyline which are provided for laser input/laser bombardment. The pattern points are distributed equidistantly in a first step, defined by coordinates x, y, z. This results in a single element of the pattern figure 108 in each case.

Pattern figure 108: The pattern figure 108 is understood to be a figure which is formed of an arrangement of individual pattern points.

Scanning field 112: The scanning field 112 is understood to mean a maximum region of the deflection of the laser beam, for example via a galvanometer scanner in the x, y and z directions.

Stitching: The term stitching comes from the field of photography and denotes the assembly of an image from a plurality of individual images. Here, it describes the assembly of individual patterns, each of which are located within the scanning field 112, to form an overall figure, namely the pattern figure 108. The pattern figure 108 exceeds the size of the scanning field 112.

Adaptive spacing: Adaptive spacing, also referred to as distance adjustment, is understood to mean an adaptation of the distances of the pattern points on the polyline.

FIG. 2 is a schematic view of a pattern figure 108 on a workpiece 102 according to an example. The pattern figure 108 was created, for example, using a machining device as is described with reference to FIG. 1.

The pattern figure 108 is divided into four patterns 231, 232, 233, 234. In order to create the pattern figure 108, the machining device has assumed four different positions 241, 242, 243, 244. The first pattern 231 is located, in the case of the first position 241, within the scanning field 112 of the machining device. The second pattern 232 is located, in the case of the second position 242, within the scanning field 112 of the machining device. The third pattern 233 is located, in the case of the third position 243, within the scanning field 112 of the machining device. The fourth pattern 234 is located, in the case of the fourth position 244, within the scanning field 112 of the machining device.

The pattern figure 108 comprises at least one first polyline 251 and at least one second polyline 252, which each extend over all patterns 231, 232, 233, 234 and merge in the fourth pattern 234 in a region E.

A region S1 represents a transition between a portion of the first polyline 251 associated with the first pattern 231, and a second portion of the first polyline 251 associated with the second pattern 232. A region S2 represents a transition between a first portion of the second polyline 252 associated with the first pattern 231, and a second portion of the second polyline 252 associated with the second pattern 232.

The described approach allows a seamless transition of the pattern figure 108 at the transitions between the patterns 231, 232, 233, 234, i.e., for example in the regions S1 and S2, and a clean merging of the polylines 251, 252 in the region E.

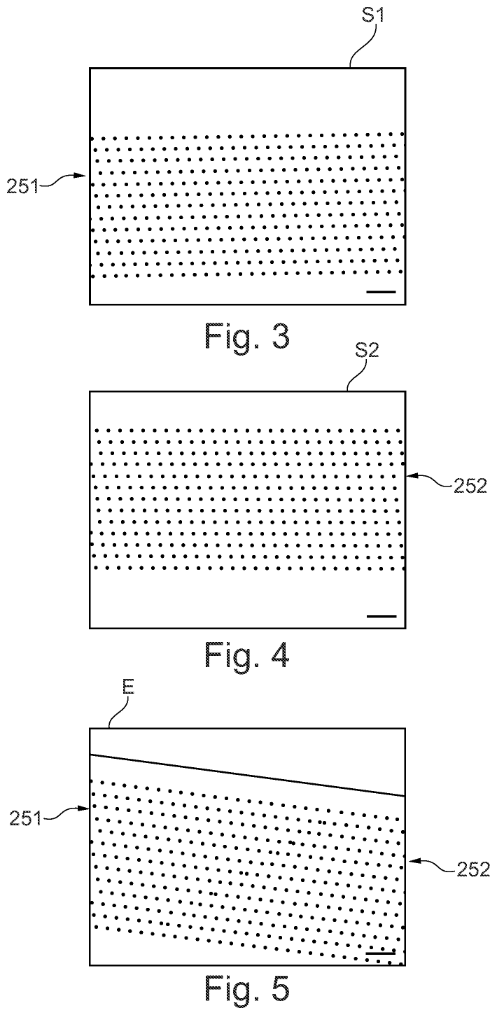

FIG. 3 shows an example of the region S1 of the pattern figure, denoted in FIG. 2. By way of example, a plurality of first polylines 251 extending in parallel with one another is shown, only one of which is provided with the reference sign, for the sake of clarity. The pattern points of the first polylines 251 each exhibit the same distance between adjacent pattern points within the region S1, i.e., at the transition between the first pattern and the second pattern of the pattern figure.

FIG. 4 shows an example of the region S2 of the pattern figure, denoted in FIG. 2. By way of example, a plurality of second polylines 252 extending in parallel with one another is shown, only one of which is provided with the reference sign, for the sake of clarity. The pattern points of the second polylines 252 each exhibit the same distance between adjacent pattern points within the region S2, i.e., at the transition between the first pattern and the second pattern of the pattern figure.

As can be seen from FIGS. 3 and 4, the stitching in the regions S1, S2 is successful.

FIG. 5 shows a view of the region E of the pattern figure, denoted in FIG. 2, for the case where the polylines 251, 252 meet without distance adjustment. This leads to two pattern points being at a distance from one another, at the meeting of the polylines 251, 252, which distance differs from the distance exhibited by the other adjacent pattern points of the polylines 251, 252.

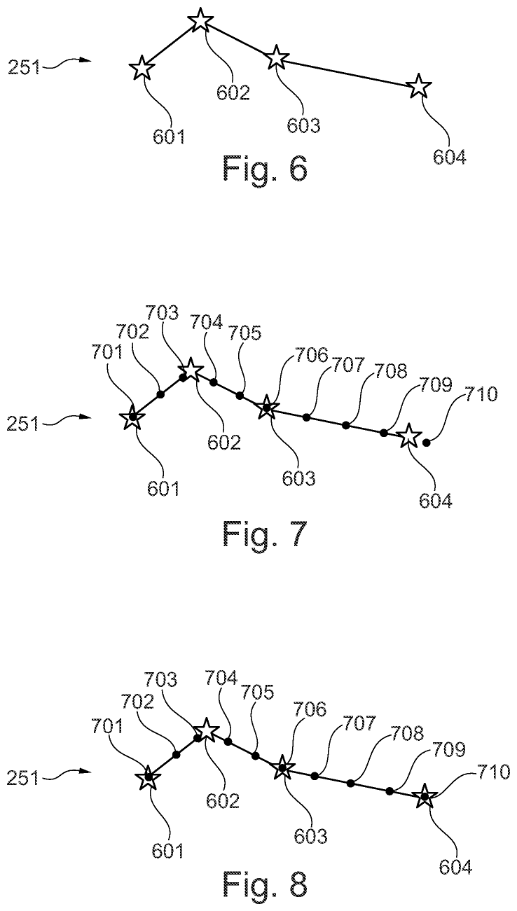

FIG. 6 is a view of an example of support points 601, 602, 603, 604 of a portion of a polyline 251.

FIG. 7 is a view of the portion of the polyline 251 shown in FIG. 6, comprising pattern points 701, 702, 703, 704, 705, 706, 707, 708, 709, 710 supplemented between the support points 601, 602, 603, 604, a distribution of the pattern points 701, 702, 703, 704, 705, 706, 707, 708, 709, 710 being carried out without distance adjustment. This has resulted in a last pattern point 710 of the portion of the polyline 251 not coinciding with the last support point 604 of the portion of the polyline 251.

FIG. 8 is a view of an example of the portion of the polyline 251 shown in FIG. 6, comprising pattern points 701, 702, 703, 704, 705, 706, 707, 708, 709, 710 supplemented between the support points 601, 602, 603, 604, a distribution of the pattern points 701, 702, 703, 704, 705, 706, 707, 708, 709, 710 being carried out with distance adjustment (adaptive spacing). This has resulted in the last pattern point 710 of the portion of the polyline 251 coinciding with the last support point 604 of the portion of the polyline 251.

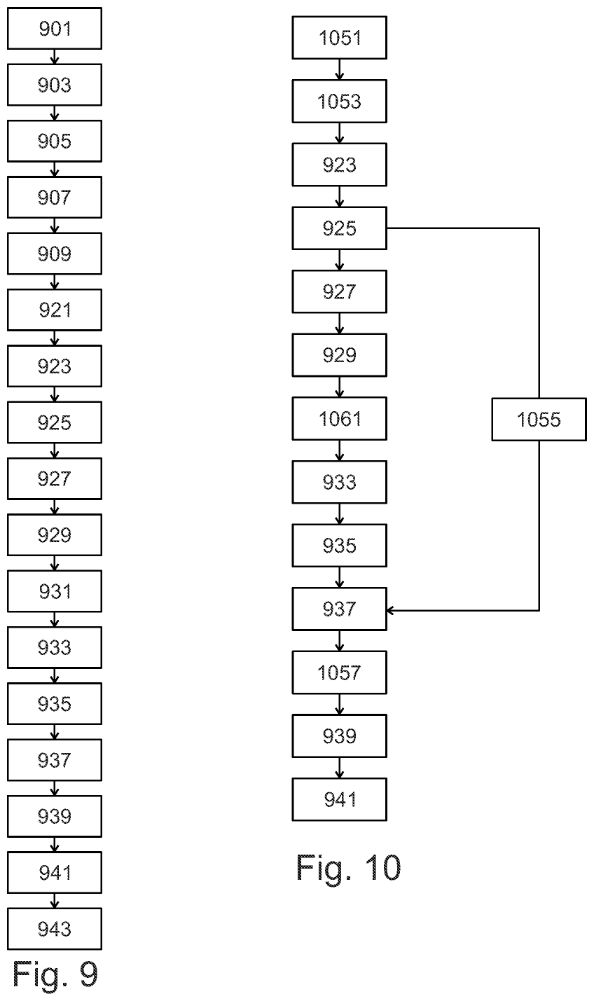

FIG. 9 is a flow diagram of an example of a method for creating a pattern figure, in a workpiece, formed of pattern points. The method is carried out, for example, in connection with a laser device as is described with reference to FIG. 1.

A process description of the method is in this case divided into a process portion to be carried out once for all workpieces, which are also referred to as components, and a component-specific process portion. The process portions can be carried out separately. According to different examples, the process portions can be supplemented by further method steps and, optionally, method steps that are not required can be omitted or supplemented by a similar method step.

First, method steps to be performed once for all workpieces are described.

In a step 901, a height profile of the workpiece is acquired. The step 901 is carried out when the workpiece is located in the device, as shown for example in FIG. 1. The height profile can be acquired automatically or, for example, using a hand-held scanner. Alternatively, height profile data already acquired once can be read in.

In a step 903, morphing of the desired pattern figure onto the height profile takes place. The morphing is carried out for example using the open source software tool Blender.

In a step 905, a division takes place into positions to be assumed for machining the workpiece, as are described for example with reference to FIG. 2. If a robot is used to align the workpiece with respect to the laser device, the positions can be regarded as robot positions, i.e., individual positions of the robot, which are defined by x, y and z coordinates. Ideal use can be made of the scanning field as a result.

in a step 907, the pattern figure is divided at the resulting stitching positions, i.e., the seam locations at the respective boundaries of the scanning field, and thus in each case at the transition to the next part of the pattern figure, as is shown for example in FIG. 2 with reference to the division, by way of example, into four positions.

In a step 909, parameters, for example image processing parameters for stitching positions, are prepared. This can be performed automatically or using a human-machine interface (HMI).

The method steps to be carried out in a component-specific manner are now described.

In a step 921, an insertion into a device is carried out, for example in the machining device described with reference to FIG. 1. The step 921 can be performed automatically or manually.

In a step 923, a portion of the pattern figure is lasered in the starting position. With reference to FIG. 2, for example the first pattern is introduced into the workpiece, while the machining device is in the first position.

In a step 925, the next position is approached. With reference to FIG. 2, for example the second position is set.

In a step 927, an image acquisition device for acquiring an image of the workpiece is aligned to a stitching position that is to be expected, i.e., to a transition between the currently lasered pattern and a pattern of the pattern figure to be lasered subsequently. For example, for this purpose a scanner of the laser device is set to the stitching position that is to be expected.

In a step 929, the stitching position is underlit, for example using light-emitting diodes.

In the following, a first step of image processing is carried out, and a result of the image processing is checked. The first step of image processing comprises a step 931 in which the image processing detects, on the basis of a light-dark contrast in at least one acquired image of the workpiece at the stitching position, possible features, and determines their focus. In a step 933, the determined foci (pixels) are converted into an x, y position. This leads to distortion correction. According to an example, the foci represent pattern points lasered into the workpiece, which pattern points were detected in the image using the image processing.

In the following, a second step of the image processing is carried out and checked for error messages. The second step comprises a step 935 of determining courses of polylines based on the foci. For example, in this case lines are sorted using image processing software for executing the image processing. In a step 937, the courses of the lines are continued. For example, the lines sorted by the image processing software are continued by linear regression, and a point to be set next, known as a reference point, is determined.

In a step 939, the reference point is used to determine adapted position data. For example, for this purpose, for example for controlling the machining device shown in FIG. 1, the starting point or the end point of a polyline is replaced by the newly determined reference point, from contour lines in a control software. In this case, according to an example, the z-coordinate from the scanner position is used. This results in the connection of the polylines in the control software at the real position of the stitching point on the workpiece.

in a step 941, the pattern points resulting from the step 939 are introduced into the workpiece. For this purpose, the results from the second step of image processing are loaded into the control software and lasering is carried out.

in a step 943, optionally a double stitch or a distance adjustment (adaptive spacing) or merging is performed in the last position, for contour closing. As a result, for example the region E shown in FIG. 2 can be implemented cleanly.

The steps 931, 933, 935, 937, 939 are, according to an example, associated with image and data processing in three steps.

The steps 929, 931, 933, 935, 937, 939, 941 are performed repeatedly for all stitching points of the current position. By way of example, the steps 929, 931, 933, 935, 937, 939, 941 are carried out for each polyline, which continues, proceeding from the pattern lasered in the starting position, in the pattern to be lasered in the next position.

If a further position follows after a current position, step 927 is returned to after the last execution of step 941 or after execution of step 943 for the current position. The steps 927, 929, 931, 933, 935, 937, 939, 941, 943 are thus carried out repeatedly for all positions.

FIG. 10 is a flow diagram of an example of a method for creating a pattern figure formed of pattern points, in a workpiece. The method is carried out, for example, in connection with a laser device as is described with reference to FIG. 1. The pattern figure is composed at least of a first pattern and a second pattern related to the first pattern.

In a step 1051, first position data are read in, which define positions of first pattern points on the workpiece, the first pattern points being associated with a first portion of a polyline of the pattern figure associated with the first pattern. For example, the position data are read in from the storage device shown in FIG. 1.

In a step 1053, a first position of the machining device is set, for example approached, in order to align a scanning field of the laser device to a first surface of the workpiece provided for introducing the first pattern.

In a step 923, the laser device is actuated for introducing the first pattern points into the first surface of the workpiece, using the first position data. During introduction, the machining device is in the first position.

In a step 925, after completion of the first pattern, a second position is set, in order to align the scanning field of the laser device to a second surface of the workpiece provided for introducing the second pattern.

In a step 1055, a course of an end of the first portion of the polyline, adjacent to the second surface, is detected. For this purpose, for example an image of the workpiece acquired by the image acquisition device of the machining device can undergo suitable image processing.

In a step 937, the course of the end of the first portion of the polyline detected in step 1055 is guided into the second surface, in order to determine a position of a reference point of a second portion of the polyline associated with the second pattern and arranged in the second surface. The step 937 can be carried out as part of the image processing.

In a step 1057, second position data are read in, which define positions of second pattern points on the workpiece, the second pattern points being associated with the second portion of the polyline, an end point of the first pattern points and a starting point of the second pattern points defining a transition of the polyline from the first pattern to the second pattern, and an end point of the second pattern points defining an end of the polyline in the second pattern. For example, the second position data are read in from the storage device shown in FIG. 1.

In a step 939, adapted second position data are determined, which define positions of the second pattern points on the workpiece that are adapted to the position of the reference point, a position of the starting point of the second pattern points being replaced by the position of the reference point.

In a step 941, the laser device is actuated for introducing the second pattern points into the second surface of the workpiece, using the adapted second position data. In this case, the machining device is in the second position.

According to an example, the step 1055 comprises detecting a step 927 in which the image acquisition device of the machining device is aligned with the transition of the polyline from the first pattern to the second pattern, a step 1061 in which an image of the transition is detected using the image acquisition device, a step 933 in which images of first pattern points in the image are acquired, and a step 935 in which the course of the end of the first portion of the polyline is determined using the images of first pattern points. Optionally, the step 1055 of detection further comprises a step 929 in which the transition of the polyline from the first pattern to the second pattern is back-lit.

According to an example, in step 939 of determining adapted second position data, an adapted position of the end point of the second pattern points is deleted if a length of the second portion of the polyline defined by the adapted positions of second pattern points on the workpiece is longer than a predetermined length of the second portion of the polyline. Alternatively, in step 939 of determining, a distance between adjacent adapted positions of the second pattern points with respect to a distance between adjacent positions of the second pattern points is changed if a length of the second portion of the polyline defined by the adapted positions of second pattern points on the workpiece differs from a predetermined length of the second portion of the polyline. This is also referred to as adaptive spacing.

The method can be carried out at least partially repeatedly and/or in a modified manner, in order to produce pattern points of further and additional polylines of the pattern figure.

In order to produce a further polyline, according to an example, in step 1051 the position data, which further define positions of further first pattern points on the workpiece, are read in, the further first pattern points being associated with a first portion of a further polyline of the pattern figure associated with the first pattern. in step 923, the laser device is further actuated for introducing the further first pattern points into the first surface of the workpiece, using the first position data, while the machining device is in the first position. In a repeated step 1055, a course of an end of the first portion of the further polyline adjacent to the second surface is detected. In a repeated step 937, the course of the end of the first portion of the further polyline is continued into the second surface, in order to determine a position of a further reference point of a second portion of the further polyline which is associated with the second pattern and is arranged in the second surface. In step 1057 of reading in second position data, the second position data are read in, which further define positions of further second pattern points on the workpiece, the further second pattern points being associated with the second portion of the further polyline, an end point of the further first pattern points and a starting point of the further second pattern points defining a transition of the further polyline from the first pattern to the second pattern, and an end point of the further second pattern points defining an end of the further polyline in the second pattern. In the step of determining adapted second position data, the adapted second position data are determined, which further define positions of the further second pattern points on the workpiece that are adapted to the position of the further reference point, a position of the starting point of the further second pattern points being replaced by the position of the further reference point. In the step 941, the laser device is further actuated for introducing the further second pattern points into the second surface of the workpiece, using the adapted second position data, while the machining device is in the second position.

In order to produce an additional polyline which merges with the polyline, according to an example, in the step 1051 the first position data are read in, which further define positions of additional first pattern points on the workpiece, the additional first pattern points being associated with a first portion of an additional polyline of the pattern figure associated with the first pattern. In the step of actuating the laser device for introducing the first pattern points, the laser device is furthermore actuated for introducing the additional first pattern points into the first surface of the workpiece using the first position data, while the machining device is in the first position. In the step 1055, a course of an end of the first portion of the additional polyline adjacent to the second surface is also detected. In the step 937 of continuing, the course of the end of the first portion of the additional polyline 1180 is furthermore continued into the second surface, in order to determine a position of an additional reference point, arranged in the second surface, of a second portion of the additional polyline associated with the second pattern. In the step 1057, the second position data are read in, which further define positions of additional second pattern points on the workpiece, the additional second pattern points being associated with a second portion of the additional polyline associated with the second pattern, an end point of the additional first pattern points and a starting point of the additional second pattern points defining a transition of the additional polyline from the first pattern to the second pattern, and an end point of the additional second pattern points defining an end of the additional polyline in the second pattern, the position of the end point of the second pattern points coinciding with the position of the end point of the additional second pattern points, in order to merge the ends of the polyline and the additional polyline. In the step 939, the adapted second position data are determined, which further define positions of the additional second pattern points on the workpiece that are adapted to the position of the additional reference point, a position of the starting point of the additional second pattern points being replaced by the position of the additional reference point. In the step 941, the laser device is further actuated for introducing the additional second pattern points into the second surface of the workpiece, using the adapted second position data, while the machining device is in the second position.

According to an example, in step 939 of determining adapted second position data, a distance between adjacent adapted positions of the additional second pattern points with respect to a distance between adjacent positions of the additional second pattern points is changed, if a length of the second portion of the additional polyline defined by the adapted positions of additional second pattern points on the workpiece is longer than a predetermined length of the second portion of the additional polyline.

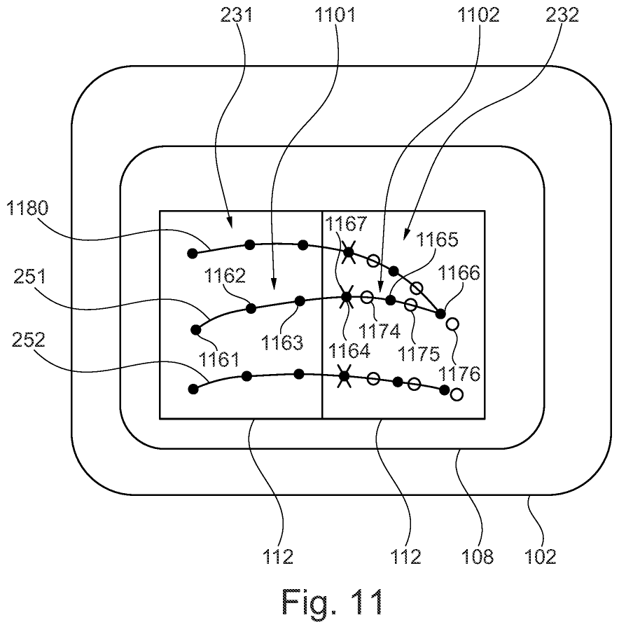

FIG. 11 is a schematic view of a pattern figure 108 on a workpiece 102. The pattern figure 108 can, for example, be produced using a method as is described with reference to FIGS. 10 and 12.

The pattern figure 108 is divided into two patterns 231, 232. In order to create the pattern figure 108, the machining device is set into two different positions. The first pattern 231 is located, in the case of the first position, within the scanning field 112 of the machining device. The second pattern 232 is located, in the case of the second position, within the scanning field 112 of the machining device.

The pattern figure 108 comprises a polyline 251 and optionally a further polyline 252. A first portion 1101 of the polyline 251 extends within the first pattern 231, and a second portion 1102 of the polyline 251 extends within the second pattern 232.

By way of example, three first pattern points 1161, 1162, 1163 from the first portion 1101 of the polyline 251 are shown, and three second pattern points 1164, 1165, 1166 from the second portion 1102 of the polyline 251 are shown. The pattern point 1164 represents a reference point 1167. The second pattern points 1164, 1165, 1166 are arranged so as to be offset, at least in part, relative to originally read-in positions 1174, 1175, 1176, in order to bring the pattern point 1164, which represents a starting point of the second pattern points 1164, 1165, 1166, into correlation with the reference point 1167. The first pattern point 1163 represents an end point of the first pattern points 1161, 1162, 1163. The second pattern point 1166 represents an end point of the second pattern points 1164, 1165, 1166.

According to an example, the further polyline 252 is shown, by way of example, in a manner corresponding to the polyline 251 with further first pattern points of a first portion associated with the first pattern 231, and with further second pattern points of a second portion associated with the second pattern 232.

The pattern figure 108 optionally comprises an additional polyline 1180. According to an example, the additional polyline 1180 is shown, by way of example, in a manner corresponding to the polyline 251 with additional first pattern points of a first portion associated with the first pattern 231, and with additional second pattern points of a second portion of the additional polyline 1180 associated with the second pattern 232.

The position 1176 of the end point of the second pattern points 1164, 1165, 1166 coincides with the position of the end point of the additional second pattern points. As a result, the ends of the polyline 251 and the additional polyline 1180 are merged. For the additional polyline 1180, adapted second position data, which result in the additional second pattern points being introduced into the workpiece in such a way that the end point of the additional polyline 1180 coincides with the pattern point 1166. This is achieved, according to an example, in that the adapted positions of the additional second pattern points are adapted to the additional reference point, and, in addition, a distance between adjacent adapted positions of the additional second pattern points is suitably adapted.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to create a pattern figure formed of pattern points in a workpiece using a laser device of a machining device, the pattern figure being composed at least from a first pattern and a second pattern that is related to the first pattern, the method comprising:
reading in first position data which define positions of first pattern points on the workpiece, the first pattern points being associated with a first portion of a polyline of the pattern figure associated with the first pattern;
setting a first position of the machining device in order to align a scanning field of the laser device onto a first surface of the workpiece provided for introducing the first pattern;
actuating the laser device to introduce the first pattern points into the first surface of the workpiece using the first position data, while the machining device is in the first position;
setting a second position in order to align the scanning field of the laser device to a second surface of the workpiece provided for introducing the second pattern;
detecting a course of an end of the first portion of the polyline adjoining the second surface;
continuing the course of the end of the first portion of the polyline into the second surface, in order to determine a position of a reference point of a second portion of the polyline associated with the second pattern and arranged in the second surface;
reading in second position data which define positions of second pattern points on the workpiece, the second pattern points being associated with the second portion of the polyline, an end point of the first pattern points and a starting point of the second pattern points defining a transition of the polyline from the first pattern to the second pattern, and an end point of the second pattern points defining an end of the polyline in the second pattern;
determining adapted second position data which define positions of the second pattern points on the workpiece, which are adapted to the position of the reference point, the position of the starting point of the second pattern points being replaced with the position of the reference point; and
actuating the laser device for introducing the second pattern points into the second surface of the workpiece using the adapted second position data, while the machining device is in the second position.

2. The method according to claim 1, wherein the step of detecting comprises a step of alignment of an image acquisition device of the machining device with the transition of the polyline from the first pattern to the second pattern, a step of detecting an image of the transition using the image acquisition device, a step of detecting images of first pattern points in the image, and a step of determining the course of the end of the first portion the polyline using the images of first pattern points.

3. The method according to claim 1, wherein the step of detecting comprises a step of underlighting the transition of the polyline from the first pattern to the second pattern.

4. The method according to claim 1, wherein, in the step of continuing, the course of the end of the first portion of the polyline is continued into the second surface by linear regression.

5. The method according to claim 1, wherein, in the step of determining adapted second position data, an adapted position of the end point of the second pattern points is deleted if a length of the second portion of the polyline defined by the adjusted positions of second pattern points on the workpiece is longer than a predetermined length of the second portion of the polyline.

6. The method according to claim 1, wherein, in the step of determining adapted second position data, a distance between adjacent adapted positions of the second pattern points relative to a distance between adjacent positions of the second pattern points is changed if a length of the second portion of the polyline defined by the adjusted positions of second pattern points on the workpiece differs from a predetermined length of the second portion the polyline.

7. The method according to claim 1, wherein, in the step of reading in first position data, the first position data further define positions of further first pattern points on the workpiece, wherein the further first pattern points are associated with a first portion of a further polyline f the pattern figure associated with a first pattern; wherein, in the step of actuating the laser device for introducing the first pattern points, the laser device is furthermore actuated for introducing the further first pattern points into the first surface of the workpiece, using the first position data, while the machining device is in the first position; wherein, in a repeated step of detecting, a course of an end of the first portion of the further polyline adjacent to the second surface is detected; wherein, in a repeated step of continuing, the course of the end of the first portion of the further polyline is continued into the second surface, in order to determine a position of a further reference point, arranged in the second surface, of a second portion of the further polyline associated with the second pattern; wherein, in the step of reading in second position data, the second position data further define positions of further second pattern points on the workpiece, wherein the further second pattern points are associated with the second portion of the further polyline, wherein an end point of the further first pattern points and a starting point of the further second pattern points define a transition of the further polyline from the first pattern to the second pattern, and an end point of the further second pattern points defines an end of the further polyline in the second pattern; wherein, in the step of determining adapted second position data, the adapted second position data are determined, which further define positions of the further second pattern points on the workpiece which are adapted to the position of the further reference point, wherein a position of the starting point of the further second pattern points is replaced by the position of the further reference point; and/or wherein, in the step of actuating the laser device for introducing the second pattern points, the laser device is furthermore actuated for introducing the further second pattern points into the second surface of the workpiece using the adapted second position data, while the machining device is in the second position.

8. The method according to claim 1, wherein, in the step of reading in first position data, which first position data define further positions additional first pattern points on the workpiece, wherein the additional first pattern points are associated with a first portion of an additional polyline of the pattern figure associated with the first pattern; wherein, in the step of actuating the laser device for introducing the first pattern points, the laser device is furthermore actuated for introducing the additional first pattern points into the first surface of the workpiece, using the first position data, while the machining device is in the first position; wherein, in the step of detecting, furthermore a course of an end of the first portion of the additional polyline adjacent to the second surface is detected; wherein, in the step of continuing, the course of the end of the first portion of the additional polyline is furthermore continued into the second surface, in order to determine a position of an additional reference point, arranged in the second surface, of a second portion of the additional polyline associated with the second pattern; wherein, in the step of reading in second position data, which second position data further define positions of additional second pattern points on the workpiece, wherein the additional second pattern points are associated with a second portion of the additional polyline associated with a second pattern, wherein an end point of the additional first pattern points and a starting point of the additional second pattern points define a transition of the additional polyline from the first pattern to the second pattern, and an end point of the additional second pattern points defines an end of the additional polyline in the second pattern, wherein the position of the end point of the second pattern points coincides with the position of the end point of the additional second pattern points, in order to merge the ends of the polyline and the additional polyline; wherein, in the step of determining adapted second position data, the adapted second position data are determined, which further define positions of the additional second pattern points on the workpiece which are adapted to the position of the additional reference point, wherein a position of the starting point of the additional second pattern points is replaced by the position of the additional reference point; and/or wherein, in the step of actuating the laser device for introducing the second pattern points, the laser device is furthermore actuated for introducing the additional second pattern points into the second surface of the workpiece using the adapted second position data, while the machining device is in the second position.

9. The method according to claim 8, wherein in the step of determining adapted second position data, a distance between adjacent adapted positions of the additional second pattern points is changed with respect to a distance between adjacent positions of the additional second pattern points, if a length of the second portion of the additional polyline defined by additional second pattern points on the workpiece is longer than a predetermined length of the second portion of the additional polyline.

10. The method according to claim 1, further comprising:
morphing of the pattern figure to a height profile of the workpiece,
defining the first position and the second position of the machining device; and
dividing the pattern figure into the first pattern and the second pattern.

11. The method according to claim 10, further comprising: recording the height profile of the workpiece.

12. A device to create a pattern figure formed of pattern points, in a workpiece, using a laser device of a machining device, wherein the device is configured to execute and actuate the steps of the method according to claim 1 in corresponding units.

13. A machining device comprising a laser device and the device according to claim 12.

14. A computer program, which is adapted to be stored on a machine-readable carrier or storage medium, a semiconductor memory, a hard disk memory, or an optical memory, and which is configured to execute and actuate the steps of the method according to claim 1.
